(19) United States
(12) Patent Application Publication
(10) Pub. No.: US 2008/0079992 A1
(43) Pub. Date: Apr. 3, 2008

(54) MULTI FUNCTION PERIPHERAL APPARATUS AND CONTROL METHOD THEREOF

(75) Inventor: Hyun-suk Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/775,323

(22) Filed: Jul. 10, 2007

(30) Foreign Application Priority Data
Sep. 29, 2006 (KR) 2006-96251

(51) Int. Cl. G06F 3/12

(52) U.S. Cl. 358/1.15

(57) ABSTRACT

A multi function peripheral apparatus includes a plurality of modules which execute respectively works, a user input part, a display part, and a control part which controls the display part to display a list of at least one work mode in which a work file is executed by a corresponding one of the plurality of modules, the work file selected by a user through the user input part and the display part.

### CROSS-REFERENCE TO RELATED APPLICATIONS

This application claims priority from Korean Patent Application No. 10-2006-0096251, filed on Sep. 29, 2006, in the Korean Intellectual Property Office, the disclosure of which is incorporated herein in its entirety by reference.

### BACKGROUND OF THE INVENTION

1. Field of the Invention

The present general inventive concept relates to a multi function peripheral apparatus and a control method thereof, and more particularly, to a multi function peripheral apparatus which allows a user to search for a work file and to perform the work without difficulty, and a control method thereof.

2. Description of the Related Art

Generally, a multi function peripheral accomplishes functions of a facsimile, a scanner and an e-mail transmission as well as a function of a printer printing data transmitted from a host computer. That is, the multi function peripheral is a complex apparatus having multi functions which integrates distinct known apparatuses such as the facsimile, the scanner and the printer.

In the conventional multi function peripheral, in order to do the works such as printing a specific file, or executing email transmission, a corresponding work mode may be selected in a menu displayed in a display part, and a specific file may be searched to be selected as a work file in the corresponding work mode. However, if a lot of files are stored in the corresponding work mode or there are a lot of files to be completed, much time can be wasted to search files.

### SUMMARY OF THE INVENTION

The present general inventive concept provides a multi function peripheral apparatus and a control method thereof to allow a user to search for a work file to complete a desired work without difficulty.

The present general inventive concept provides a multi function peripheral apparatus and a control method thereof so that a user selects and operates a plurality of work modes for a work file.

The present general inventive concept provides a multi function peripheral apparatus and a control method thereof so that a user selects a plurality of work files to concurrently complete a specific work.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept can be achieved by providing a multi function peripheral apparatus, comprising a plurality of modules which execute respectively works, a user input part, a display part, and a control part which controls the display part to display a list of one or more work modes in which a work file is executed by the plurality of modules, the work file selected by a user through the user input part and the display part.

The plurality of modules may include at least one of a printer module, a scanner module and a fax module.

The control part may control to display at least one of a printer mode to operate the printer module, a scanner mode to operate the scanner module, a fax mode to operate the fax module, and an e-mail mode to transmit and receive a mail in the list of the work modes for the work file on the display part.

The control part may control the display part to display the list of the work modes in which the work file is executed by the plurality of modules based on an extension of the work file.

The control part may grant a different work authority according to a user or a directory, and may control the display part to differently display the list of the work modes of which work file is executed by a user or a directory.

The control part may control so that the user can set the work mode available for the work file through the user input part.

If one of the work modes is selected through the user input part, the control part may drive a corresponding module to a corresponding work mode so that the work file is processed according to the selected work mode.

If a plurality of work modes is selected through the user input part, the control part may drive corresponding modules to corresponding work modes so that the work file is processed according to the selected work modes.

If the plurality of work modes are selected through the user input part, the control part may control the display part to display an option with respect to corresponding work modes and to be inputted the option to process the work file according to the selected work modes.

If a plurality of work files is selected by the user, the control part may control the display part to display the list of the work modes available for all of the work files.

The multi function peripheral apparatus may further include a USB connection part which interfaces with a USB storing media.

The foregoing and/or other aspects and utilities of the present general inventive concept can also be achieved by providing a control method of a multi function peripheral apparatus comprising a plurality of modules which execute respectively works, the control method comprising searching and selecting a work file through a user input part and a display part by a user, and displaying a list of one or more work modes in which the work file is executed by the plurality of modules, in the display part.

The displaying of the list may include displaying at least one of a printer mode to operate the printer module, a scanner mode to operate the scanner module, a fax mode to operate the fax module, and an e-mail mode to transmit and receive a mail in the list of the work modes for the work file.

The selecting of the work file may include examining the list of the work modes in which the work file is executed by the plurality of modules based on an extension of the work file.

The control method of the multi function peripheral apparatus may further include granting a different work authority according to a user or a directory, and differently setting the list of the work mode which is executed by a user or a directory depending on the work authority.

The control method of the multi function peripheral apparatus may further include setting the work mode available for the work file through the user input part by the user.

If the work mode is selected through the user input part, the displaying of the list may further include driving a corresponding module to a corresponding work mode so that the work file is processed according to the selected work mode.

If a plurality of work modes are selected through the user input part, the displaying of the list may further include driving corresponding modules to corresponding work modes so that the work file is processed according to the selected work modes.

If the plurality of work modes is selected through the user input part, the displaying of the list may further include selecting or inputting an option with respect to corresponding work modes to process the work file according to the selected work modes.

If a plurality of work files is selected by the user in the selecting stage, the displaying of the list may include displaying the list of the work modes available for all of the work files.

The foregoing and/or other aspects and utilities of the present general inventive concept can also be achieved by providing a multi function peripheral apparatus including a user interface part, and a control part to control the user interface part to generate a work mode screen including a filed display area to display one or more work files and a work list display area to display one or more work modes to be executed according to a corresponding one of the one or more work files.

At least one of the one or more work modes may have an authorization to be executed automatically when the corresponding work file is selected.

One of the one or more work modes may have a higher priority to be executed than other work modes.

The apparatus may further include one or more modules, and the control part may control the one or more modes to perform one or more operations according to a selected one of the work file.

The apparatus may further include a user input part to select the work files; and a display to display the work mode screen.

The foregoing and/or other aspects and utilities of the present general inventive concept can also be achieved by providing a multi function peripheral apparatus including one or more modules, and a control part to generate a work mode screen including one or more work files and one or more work modes corresponding to the one or more work files, and to control the one or more modules according to a selection of the one or more work files and the one or more work modes.

### BRIEF DESCRIPTION OF THE DRAWINGS

The above and/or other aspects and utilities of the present general inventive concept will become apparent and more readily appreciated from the following description of the exemplary embodiments, taken in conjunction with the accompanying drawings, in which:

FIG. 1 is a block diagram illustrating a multi function peripheral apparatus according to an exemplary embodiment of the present general inventive concept;

FIG. 2 is a schematic flowchart illustrating a control method of a multi function peripheral apparatus according to an exemplary embodiment of the present general inventive concept;

FIG. 3 is a flowchart illustrating the control method of the multi function peripheral apparatus illustrated in FIG. 2; and

FIGS. 4A and 4B illustrate examples of a work mode screen according an embodiment to the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The exemplary embodiments are described below so as to explain the present general inventive concept by referring to the figures.

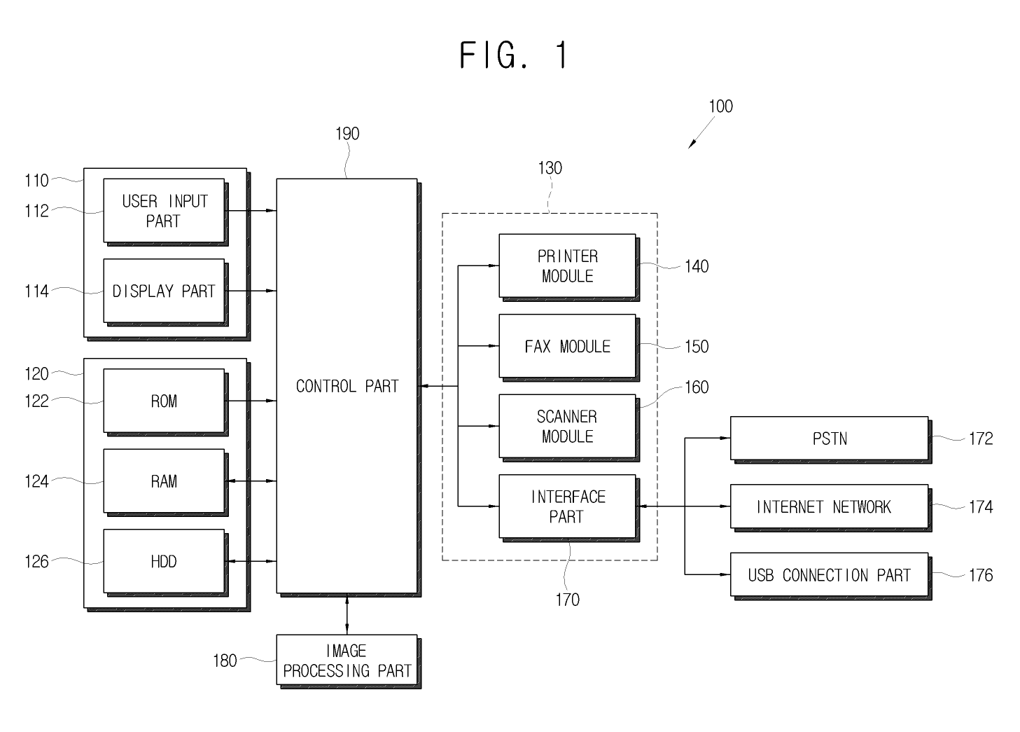

As illustrated in FIG. 1, a multi function peripheral apparatus 100 according to an exemplary embodiment of the present general inventive concept comprises an operation panel part 110, a storing part 120, a plurality of module parts 130, an image processing part 180 and a control part 190.

The operation panel part 110 includes a user input part 112 and a display part 114 as a user interface so that a user can input a proper order to the multi function peripheral 100.

The user input part 112 includes a plurality of function keys to set and select functions which the multi function peripheral apparatus 100 supports, and a key input signal according to operation of the function keys is inputted to the control part 190. Especially, the user input part 112 is provided with keys for searching and selecting a work file.

The display part 114 typically employs a liquid crystal display (LCD), and displays an operation state and a function of the multi function peripheral 100 depending on control of the control part 190.

The storing part 120 includes a read-only memory ROM 122, a random-access memory RAM 124 and an a hard disk drive HDD 126.

The ROM 122 is a non-volatile memory element to store data even when power is turned off, and comprises a flash memory, and other conventional memory elements. The ROM 122 stores various control programs necessary to complete various functions of the multi function peripheral apparatus 100, a firmware to perform a function the plurality of module parts 130 supports, a data transmission protocol, etc. Also, if the ROM 122 comprises a flash memory, the ROM 122 may store a plurality of fax numbers and e-mail addresses of receiving parties.

The RAM 124 is a volatile memory element to lose data if power is turned off, and stores various data generated during operations of the multi function peripheral apparatus 100 operates. Also, the RAM 124 stores data the plurality of module parts 130 intends to execute. That is, the RAM 124 temporarily stores image data obtained by scanning of a scanner module 160, a fax data received by fax module 150, and mail data received through an interface part 170 from an external communication device, etc.

The HDD 126 is one or more storing media that are used to store data in the multi function peripheral apparatus 100. The HDD 126 is operated by a file system which attaches names to files, and logically positions them for storage or search. The files are positioned in a folder or a sub directory of a hierarchical structure.

The plurality of module parts 130 comprises a printer module 140, the fax module 150, the scanner module 160 and the interface part 170 which can respectively perform independent functions.

The printer module 140 prints print data depending on control of the control part 190. Here, the print data may be image data obtained by scanning of the scanner module 160, fax data received through the fax module 150, mail data received through the interface part 170 from an external communication device, and other known data in the art.

The fax module 150 modulates fax data into an analogue signal and transmits the modulated signal to an external facsimile depending on control of the control part 190. The fax module 150 demodulates analogue type fax data transmitted from an external facsimile into digital type fax data, and sends the demodulated data to the control part 190.

The scanner module 160 scans a scan target document to obtain image data depending on the control of the control part 190. The scanner module 160 is operated if a scanner mode, a fax mode, or a copy mode is selected for the multi function peripheral apparatus 100 to complete functions of e-mail, fax, scanning or copy. The image data obtained by scanning of the scanner module 160 is temporarily stored in the RAM 124, and is printed by the printer module 140, or transmitted to an external communication device through the interface part 170.

The interface part 170 transmits mail data to an external mail server (not illustrated), and receives mail data transmitted from the external mail server. The mail data received through the interface part 170 is stored in the RAM 124 or printed by the printer module 140. The interface part 170 transmits and receives the mail data by using one of access types of a public switched telephone network (PSTN) 172 and an Internet network 174.

A USB connection part 176 is connected with a host (not shown) or a USB storing media (not shown).

The image processing part 180 converts text data, etc., into image data, and has the function of reduction or magnification of an image using the image data.

The control part 190 controls an overall operation of the multi function peripheral apparatus 100 depending on a control program stored in the ROM 122. The control part 190 controls the plurality of module parts 130 depending on an operation signal of the function keys provided in the user input part 112. If a printer mode is selected, the control part 190 drives the printer module 140. If a scanner mode is selected, the control part 190 drives the scanner module 150. If a fax mode is selected, the control part 190 operates the fax module 160. Also, if an e-mail mode is selected, the control part 190 transmits and receives mail data through the interface part 170.

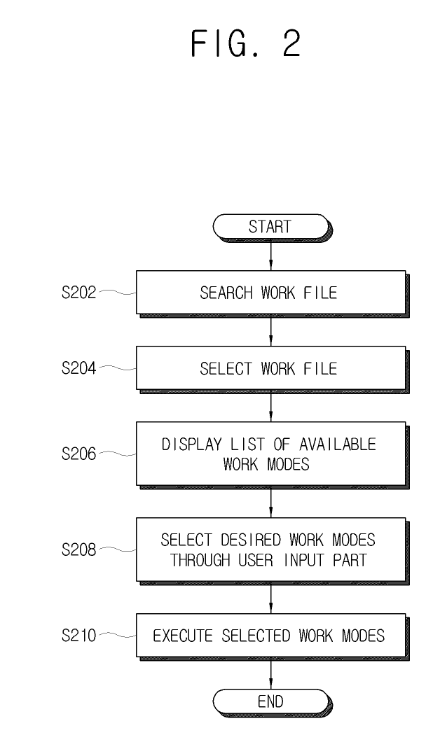

FIG. 2 is a flowchart schematically illustrating a control method of a multi function peripheral apparatus 100 according to an exemplary embodiment of the present general inventive concept.

Referring to FIGS. 1 and 2, a user searches for a work file to be executed in the multi function peripheral apparatus 100 in the HDD 126 or the external USB storing media connected through the USB connection part 176, through the user input part 112 and the display part 114 (S202). The user searches a folder or a sub directory in which the work file is located to search for the work file by operating keys provided in the user input part 112.

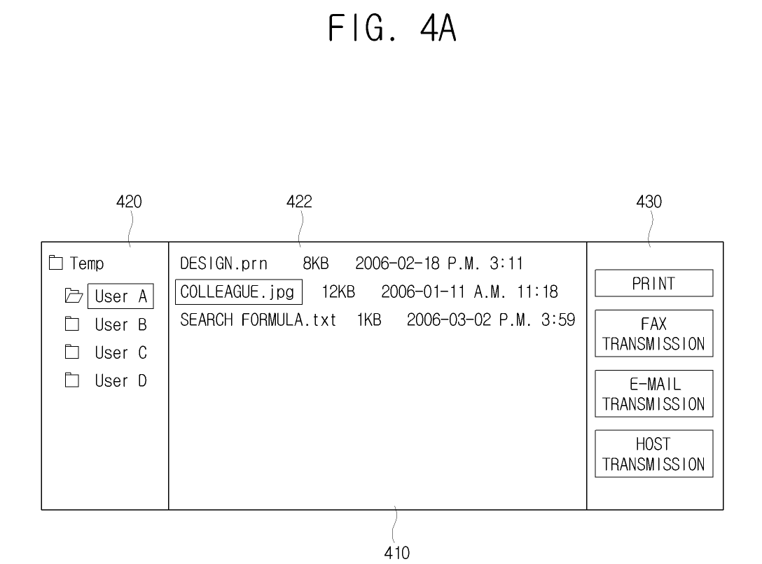

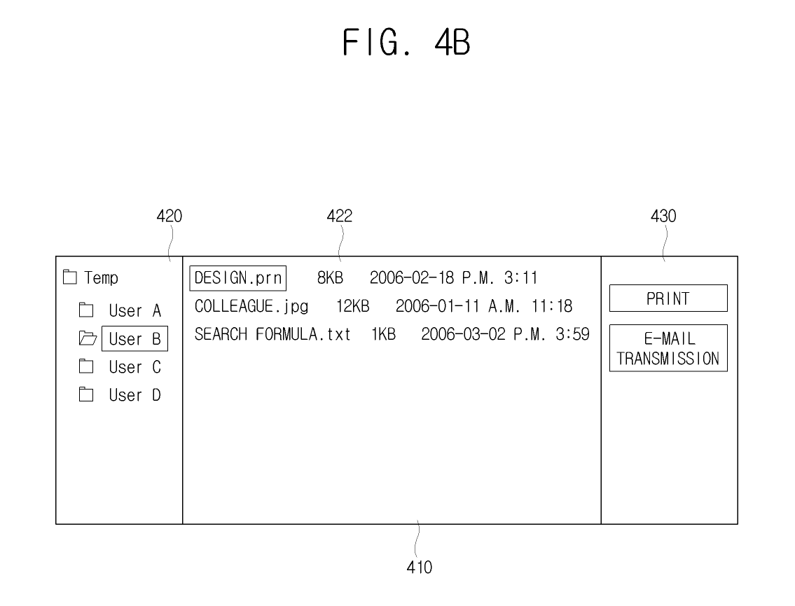

Then, the work file is selected among a plurality of files existing in the folder or the sub directory (S204). The control part 190 displays a list of work modes which a plurality of module parts 130 support for the selected work file (S206). FIG. 4A illustrates an example of a work mode screen 410 performed by the present general inventive concept. As illustrated in FIG. 4A, the work mode screen 410 comprises a directory display area 420 displaying a folder or a sub directory, a file display area 422 to display a plurality of files existing in the folder or the sub directory, and a work list display area 430 to display a list of one or more available work modes if at least one of the files is selected from the folder or the subdirectory as a work file through the user input part 112.

Referring to FIG. 4A, if a file of “colleague” is selected, the work list display area 430 of the work mode screen 410 displays an available work mode list including a print, a fax transmission, an e-mail transmission and a host transmission.

The work modes may be a work mode to be performed in the multi function peripheral apparatus 100 or in an external device connected to the multi function peripheral apparatus 100 through, for example, the interface part 170.

The control part 190 may generate the work mode list displayed in the work mode screen 410 by automatic file sorting using a file extension. For example, referring to FIG. 4A, if the file extension is “jpg”, the control part 190 displays a print, a fax transmission, an e-mail transmission and a host transmission which the multi function peripheral apparatus 100 can performs, in the work mode screen 410. If the file extension is “exe”, the work mode screen 410 displays the list including only an e-mail transmission and a host transmission since an image cannot be created in a case that the file extension is “exe.”

Also, the work mode list displayed in the work mode screen 410 may display in a mode selection screen (not shown) in the display part 114 so that a user can select a work mode which can be executed for the work file by the multi function peripheral apparatus 100 through the user input part 112.

Also, the work mode list displayed in the work mode screen 410 may be executed according to authorization or a higher priority given by a user to correspond to a folder or a sub directory. That is, referring to FIG. 4B, only printing may be authorized to be executed if a user B is different from a user A although the file is same as the one illustrated in FIG. 4A.

If the user selects the work mode to be executed, in the work mode list through the user input part 112 (S208), the control part 190 drives the corresponding module according to the selected work mode to execute work (operation) corresponding to the work file (S210).

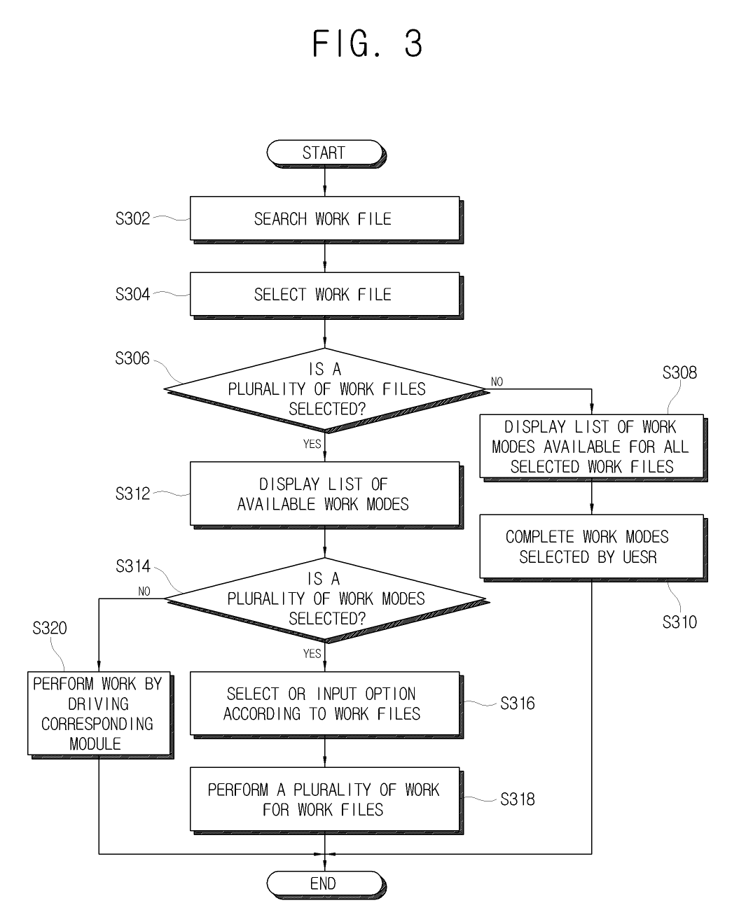

FIG. 3 is a flowchart illustrating the control method of the multi function peripheral apparatus 100 illustrated in FIGS. 1 and 2.

A user searches a folder or a subdirectory for a work file to be executed in the multi function peripheral apparatus 100 in an HDD 126 or an external USB storing medium connected through a USB connection part 176, through a user input part 112 and a display part 114 (S302). Then, the user selects the work file among a plurality of files existing in a folder or a sub directory (S304).

If the work file selected by the user is plural (S306), a control part 190 displays a list of one or more work modes which are available commonly for all selected work files (S308). For example, referring to FIGS. 4A and 4B, files “colleague” and “design” are selected by a user in the file display area 422. Since the extension of the file ‘colleague’ is ‘jpg’, a print mode, a fax mode, an e-mail mode and a host transmission mode can be supported for the file “colleague” or can be performed according to the file “colleague.” Alternatively, since the extension of the file “design” is “prn”, the print mode and the e-mail mode can be supported for the file “design” or can be performed according to the file “design.” Accordingly, the print mode and the e-mail mode are displayed in a work list display area 430 according to selection of the file “design.”

If the user selects a work mode displayed in the work list display area 430, and executes the selected work mode, a corresponding module is operated to process the plurality of work files (S310).

If a single work file is selected by the user, the control part 190 displays a list of all work modes available for the selected work file in the display part 114 (S312).

Then, if a plurality of work modes is selected by the user (S314), an option for the corresponding work mode is inputted (S316). For example, if the fax mode and the e-mail mode are selected, there may be input a receiving part number and a receiving party name related to the fax mode, and a mail address, a title and a receiving party name related to the e-mail mode.

Then, if all options for executing a corresponding work mode are inputted, a plurality of works for the work files are simultaneously or sequentially executed depending on programs (S318).

If a single work mode is selected by the user, the control part 190 drives a corresponding module to complete a corresponding work (S320).

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, the present general inventive concept provides a multi function peripheral apparatus and a control method thereof allowing a user to search for a work file to easily perform a desired work.

Also, the present general inventive concept provides a multi function peripheral apparatus and a control method thereof selecting and operating a plurality of work modes for a work file.

Also, the present general inventive concept provides a multi function peripheral apparatus and a control method thereof selecting a plurality of work files to concurrently execute a specific work.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A multi function peripheral apparatus, comprising:
a plurality of modules which execute respectively works;
a user input part;
a display part; and
a control part which controls the display part to display a list of at least one work mode in which a work file is executed by a corresponding one of the plurality of modules, the work file selected by a user through the user input part and the display part.

2. The multi function peripheral of claim 1, wherein the plurality of modules comprise one or more of a printer module, a scanner module and a fax module.

3. The multi function peripheral of claim 2, wherein the control part controls to display at least one of a printer mode to operate the printer module, a scanner mode to operate the scanner module, a fax mode to operate the fax module, and an e-mail mode to transmit and receive a mail in the list of the work mode for the work file on the display part.

4. The multi function peripheral of claim 1, wherein the control part controls the display part to display the list of the work mode in which the work file is executed by the plurality of modules based on an extension of the work file.

5. The multi function peripheral of claim 1, wherein the control part grants a different work authority according to a user or a directory and controls the display part to differently display the list of the work mode which is executed by a user or a directory.

6. The multi function peripheral of claim 1, wherein the control part controls so that the user can set the work mode available for the work file through the user input part.

7. The multi function peripheral of claim 1, wherein if the work mode is selected through the user input part, the control part drives a corresponding module to a corresponding work mode so that the work file is processed according to the selected work mode.

8. The multi function peripheral of claim 1, wherein if a plurality of work modes is selected through the user input part, the control part drives corresponding modules to corresponding work modes so that the work file is processed according to the selected work modes.

9. The multi function peripheral of claim 8, wherein if the plurality of work modes are selected through the user input part, the control part controls the display part to display an option with respect to corresponding work modes and to be inputted the option to process the work file according to the selected work modes.

10. The multi function peripheral of claim 1, wherein if a plurality of work files is selected by the user, the control part controls the display part to display the list of the work mode available for all of the work files.

11. The multi function peripheral of claim 1, further comprising a USB connection part which is interfaced with a USB storing media.

12. A control method of a multi function peripheral apparatus comprising a plurality of modules which execute respectively works, the control method comprising:
searching and selecting one or more work files through a user input part and a display part by a user; and
displaying a list of at least one work mode in which the work file is executed by the plurality of modules, in the display part.

13. The control method of claim 12, wherein the plurality modules comprise one or more of a printer module, a scanner module, a fax module, and an interface module, and the displaying of the list comprises displaying at least one of a printer mode to operate the printer module, a scanner mode to operate the scanner module, a fax mode to operate the fax module, and an e-mail mode to transmit and receive a mail in the list of the work mode to operate the interface module for the work file.

14. The control method of claim 13, wherein the selecting of the work file comprises examining the list of the work mode in which the work file is executed by the plurality of modules based on an extension of the work file.

15. The control method of claim 13, further comprising:
granting a different work authority according to a user or a directory, and differently setting the list of the work mode which is executed by a user or a directory depending on the work authority.

16. The control method of claim 13, further comprising:
setting the work mode available for the work file through the user input part by the user.

17. The control method of claim 12, wherein if the work mode is selected through the user input part, the displaying of the list comprises driving a corresponding module to a corresponding work mode so that the work file is processed according to the selected work mode.

18. The control method of claim 12, wherein if a plurality of work modes are selected through the user input part, the displaying of the list comprises driving corresponding modules to corresponding work modes so that the work file is processed according to the selected work modes.

19. The control method of claim 18, wherein if the plurality of work modes is selected through the user input part, the displaying of the list comprises selecting or inputting an option with respect to corresponding work modes to process the work file according to the selected work modes.

20. The control method of claim 12, wherein if a plurality of work files is selected by the user in the selecting stage, the displaying of the list comprises displaying the list of the work mode available for all of the work files.

21. A multi function peripheral apparatus comprising:
a user interface part; and
a control part to control the user interface part to generate a work mode screen including a filed display area to display one or more work files and a work list display area to display one or more work modes to be executed according to a corresponding one of the one or more work files.

22. The apparatus of claim 21, wherein at least one of the one or more work modes has an authorization to be executed automatically when the corresponding work file is selected.

23. The apparatus of claim 21, wherein one of the one or more work modes has a higher priority to be executed than other work modes.

24. The apparatus of claim 21, further comprising:
one or more modules, wherein the control part controls the one or more modes to perform one or more operations according to a selected one of the work file.

25. The apparatus of claim 21, further comprising:
a user input part to select the work files; and
a display to display the work mode screen.

26. A multi function peripheral apparatus comprising:
one or more modules; and
a control part to generate a work mode screen including one or more work files and one or more work modes corresponding to the one or more work files, and to control the one or more modules according to a selection of the one or more work files and the one or more work modes.
